(19) United States
(12) Patent Application Publication
(10) Pub. No.: US 2026/0167260 A1
(43) Pub. Date: Jun. 18, 2026

(54) STEER-BY-WIRE SYSTEM

(71) Applicants: HYUNDAI MOTOR COMPANY, Seoul (KR); KIA CORPORATION, Seoul (KR)

(72) Inventors: Young Uk Park, Hwaseong-si (KR); Jae Kil Lee, Hwaseong-si (KR); Sung Jin Moon, Hwaseong-si (KR)

(73) Assignees: HYUNDAI MOTOR COMPANY, Seoul (KR); KIA CORPORATION, Seoul (KR)

(21) Appl. No.: 19/259,836

(22) Filed: Jul. 3, 2025

(30) Foreign Application Priority Data
Dec. 17, 2024 (KR) 10-2024-0188318

(51) Int. Cl. B62D 5/04

(52) U.S. Cl. CPC B62D 5/0493; B62D 5/0484

(57) ABSTRACT

A steer-by-wire system includes a first control unit including a first CAN communication unit disposed in an SFA and connected to a CAN communication line, a second control unit including a second CAN communication unit disposed in an RWA and connected to the CAN communication line, a steering angle sensor configured to measure an input of a steering wheel and connected to the first control unit through the CAN communication line, and an R-CAN communication line to which the steering angle sensor and a portion of the second control unit are connected. In particular, when a failure of the SFA is determined, the second control unit receives data from the steering angle sensor using the R-CAN communication line to perform steering input to a wheel of a vehicle.

### CROSS-REFERENCE TO RELATED APPLICATION

This application claims, under 35 U.S.C. § 119(a), the benefit of and priority to Korean Patent Application No. 10-2024-0188318, filed on Dec. 17, 2024, the entire contents of which are incorporated herein by reference.

### TECHNICAL FIELD

The present disclosure relates to a steer-by-wire system. More particularly, the present disclosure relates to a steer-by-wire system configured to provide backup functionality.

### BACKGROUND

A steer-by-wire (SBW) system is a steering system in which the mechanical connection between a steering wheel and a wheel of a vehicle is removed. The SBW system receives a rotation signal of the steering wheel through an electronic control unit (ECU), and steers the vehicle by operating a steering assist motor connected to the wheel, based on the received rotation signal.

Because the SBW system excludes the mechanical connection structure of an conventional steering system, the SBW system may increase the degree of freedom in layout according to the configuration of a steering system, improve fuel efficiency, and remove disturbances which are reversely transmitted from the wheels.

Furthermore, so as to secure redundancy, the SBW system includes a steering force actuator (SFA) and a road wheel actuator (RWA), each including one or more controllers.

The SBW system uses an internal controller area network (CAN) communication for transmitting and receiving information between the two controllers, each in the SFA and the RWA. Furthermore, the SBW system may control the SFA and the RWA in response to the steering angle received from a steering angle sensor.

However, in the event of failure of the SFA, control of the RWA is performed to maintain backup functionality without receiving a steering angle from the steering angle sensor, and as a result, steering output reflecting the actually applied steering angle signal cannot be provided.

The above information disclosed in this Background section is only to enhance understanding of the background of the present disclosure, and therefore it may contain information that does not form the prior art that is already known to a person of ordinary skill in the art.

### SUMMARY

The present disclosure provides a communication environment that secures redundancy in the event of a failure of an SFA of a steer-by-wire system, thereby addressing the problems associated with the prior art.

The present disclosure also provides a communication environment in which a steering angle sensor and an RWA directly communicate with each other in the event of a failure of the SFA.

The objects of the present disclosure are not limited to the foregoing, and other objects of the present disclosure not mentioned herein may be understood based on the following description, and may be understood more clearly through the embodiments of the present disclosure. In addition, the objects of the present disclosure may be realized by means and combinations thereof indicated in the claims.

In one aspect of the present disclosure, a steer-by-wire system includes: a first control unit including a first CAN communication unit disposed in an SFA and connected to a CAN communication line, a second control unit including a second CAN communication unit disposed in an RWA and connected to the CAN communication line, a steering angle sensor configured to measure an input of a steering wheel and connected to the first control unit through the CAN communication line, and an R-CAN communication line to which the steering angle sensor and a portion of the second control unit are connected. In particular, when the failure of the SFA is determined, the second control unit receives data from the steering angle sensor using the R-CAN communication line to perform steering input to a wheel of a vehicle.

In an embodiment of the present disclosure, the second control unit in the RWA may include a first controller including the second CAN communication unit, and a second controller including an R-CAN communication unit connected to the R-CAN communication line.

In another embodiment of the present disclosure, the steer-by-wire system may further include a first battery line connected to the first control unit, the first controller, and the steering angle sensor.

In still another embodiment of the present disclosure, the steer-by-wire system may further include a second battery line connected to the second controller.

In yet another embodiment of the present disclosure, the SFA may include a first motor configured to output a reaction force to the steering wheel, and a first sensor configured to measure a driving amount of the first motor. In particular, the first control unit may control the driving amount of the first motor through the first battery line.

In still yet another embodiment of the present disclosure, when the failure of the SFA is determined, the second controller may transmit and receive data to and from the steering angle sensor through the R-CAN communication line.

In a further embodiment of the present disclosure, the failure of the SFA may include at least one of a short circuit of the first battery line, a failure of the first control unit, a failure of the first CAN communication unit, or a failure of the CAN communication line.

In another further embodiment of the present disclosure, the steering angle sensor may include a built-in battery pack, and the steering angle sensor may measure the steering angle input of the steering wheel through the built-in battery pack in response to the failure of the SFA.

In still another further embodiment of the present disclosure, the first control unit may be connected to the first controller through a P-CAN communication.

In yet another further embodiment of the present disclosure, the first controller and the second controller may be connected to each other through an input and output terminal of a general purpose input output (GPIO).

In another embodiment, a steer-by-wire system comprises: a steering force actuator (SFA) including a first control unit and a first CAN communication unit connected to a CAN communication line; a road wheel actuator (RWA) including a second control unit and a second CAN communication unit connected to the CAN communication line; a steering angle sensor configured to sense steering input from a steering wheel and connected to the first control unit through the CAN communication line; a redundant CAN (R-CAN) communication line connecting the steering angle sensor to the second CAN communication unit. In particular, the second control unit is configured to: receive steering input information from the steering angle sensor through the R-CAN communication line in response to detection of a failure of the SFA, and steer a wheel based on the received steering input information.

In an embodiment, the second control unit comprises: a first controller associated with the second CAN communication unit; and a second controller associated with an R-CAN communication unit connected to the R-CAN communication line.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given herein below by way of illustration only, and thus are not limitative of the present disclosure, and wherein:

FIG. 1 illustrates the structure of a steer-by-wire system in an embodiment of the present disclosure;

FIG. 2 illustrates connection relationships in a steer-by-wire system according to an embodiment of the present disclosure;

FIG. 3 illustrates a communication relationship in a normal operation of a steer-by-wire system according to an embodiment of the present disclosure; and

FIG. 4 illustrates a communication relationship in a steer-by-wire system upon failure of the SFA according to an embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Hereinafter, embodiments of the present disclosure are described in detail with reference to the accompanying drawings. The embodiments of the present disclosure may be modified into various forms, and the scope of the present disclosure should not be construed as being limited to the following embodiments. The embodiments are provided to more clearly explain the present disclosure to those having ordinary skill in the art.

In addition, terms such as “. . . portion,” “. . . unit,” “. . . module,” etc. used in this specification each refer to a unit that processes at least one function or operation, and may be implemented as hardware, software or a combination thereof. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable

### Media, As Part of the Apparatus.

The terminology used herein is for the purpose of describing particular embodiments only, and is not intended to be limiting. A singular representation may include a plural representation unless it represents a definitely different meaning from the context.

It should be understood that, although the terms “first,” “second,” etc. may be used herein to describe various similar elements, these elements should not be construed as being limited by these terms. These terms are only used to distinguish one element from another. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Further, various embodiments herein may be implemented by software, e.g., a program, including commands stored in a storage medium readable by a machine, e.g., a computer (a machine-readable storage medium). The machine is a device capable of calling a stored command from a storage medium and operating in accordance with the called command, and may include an electronic device (e.g., a server) according to the embodiments disclosed herein. The command may include code generated by a compiler or code that may be executed by an interpreter. The machine-readable storage medium may be provided in the form of a non-transitory storage medium. Here, “non-temporary” means that the storage medium does not contain a signal and is tangible, but does not mean that data is stored semi-permanently or temporarily in the storage medium.

Also, according to an embodiment in this specification, a method according to various embodiments disclosed herein may be provided included in a computer program product. The computer program product may be traded as a commodity between a seller and a purchaser. The computer program product may be distributed in the form of a machine-readable storage medium (e.g., compact disc read only memory (CD-ROM)) or online via an application store (e.g., Play Store™). In the case of online distribution, at least a portion of the computer program product may be at least temporarily stored in a storage medium, such as a memory of a manufacturer's server, an application store's server, or a relay server, or temporarily generated.

A control unit refers to an electrical control unit (ECU) belonging to the ECU level, and may be a device integrally controlling multiple electronic devices used in a vehicle. For example, the control unit may control all of processors belonging to the processor level and controllers belonging to the controller level. The control unit may receive sensing data from the processors, generate a control command for controlling a controller based on circumstances, and transmit the control command to the controllers. In this specification, for convenience of explanation, the ECU level is described as being higher than the processor level, however, there may be a case in which one of the processors belonging to the processor level serves as an ECU, or two processors are combined to serve as an ECU.

Hereinafter, embodiments are described in detail with reference to the accompanying drawings. In the following description with reference to the accompanying drawings, identical or corresponding components are designated by the same reference numerals, and redundant descriptions thereof have been omitted.

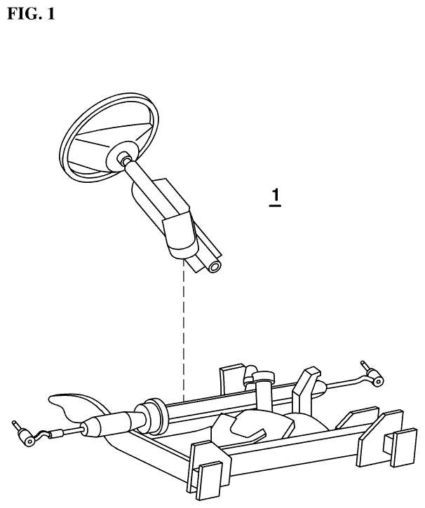

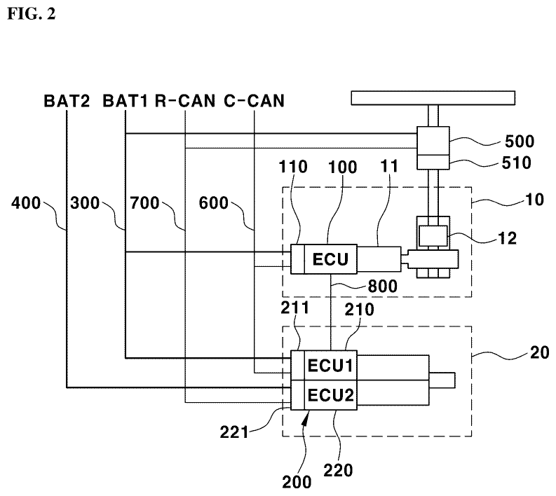

FIG. 1 is a view illustrating the structure of a steer-by-wire system according to an embodiment of the present disclosure, and FIG. 2 is a diagram showing the connection relationships in a steer-by-wire system according to an embodiment of the present disclosure.

As illustrated in FIG. 1, the steer-by-wire system (SBWS) 1, which is a steering device provided in a vehicle, includes a steering force actuator (SFA) 10 configured to generate a reaction force by being connected to a steering wheel, and a road wheel actuator (RWA) 20 configured to control a travelling direction by controlling a wheel.

The SFA 10 includes a first motor 11 configured to generate a reaction force and a first sensor 12 configured to measure an angular velocity of the steering wheel, and the SFA 10 operates in response to the manipulation of the steering wheel. Furthermore, the SFA 10 includes a steering angle sensor 500 disposed on the column of the steering wheel and configured to measure a steering angle input of the steering wheel.

In response to the steering angle input measured by the steering angle sensor 500, a first control unit 100 in the SFA 10 controls the driving amount of the first motor 11, and the first sensor 12 measures a reaction force corresponding to the amount of the steering angle input of the steering wheel corresponding to the output driving amount of the first motor 11.

Therefore, the SFA 10 is configured to provide the reaction force corresponding to the steering input by driving the first motor 11 and to re-measure the reaction force using the first sensor 12.

Furthermore, the SFA 10 includes the first control unit 100, wherein the first control unit 100 includes a first processor (micro controller unit: MCU) and a first CAN communication unit 110. The first control unit 100 receives the steering angle input of the steering wheel through the steering angle sensor 500.

The first processor of the first control unit 100 communicates through the first CAN communication unit 110. The first CAN communication unit 110 is configured to communicate with a second CAN communication unit 211 disposed in the RWA 20 and with the steering angle sensor 500 through a controller area network (CAN) communication line.

The RWA 20 includes a drive shaft (not shown) connected to a wheel, a rack (not shown) provided on the drive shaft, a steering gear (not shown), and a motor (not shown) configured to control the steering gear. The RWA 20 controls the steering gear through the motor in response to a signal of the SFA 10, and adjusts the angle of the wheel accordingly to control the travelling direction.

The RWA 20 includes a second control unit 200, wherein the second control unit 200 has a dual structure including a first controller 210 and a second controller 220. The first controller 210 and the second controller 220 may be connected to each other through a general purpose input output (GPIO). Furthermore, the first control unit 100 is connected to the first controller 210 through a private controller area network (P-CAN) communication line 800.

As an embodiment of the present disclosure, the first controller 210 includes a second processor and the second CAN communication unit 211. The second controller 220 includes a third processor and a third CAN communication unit 221 connected to an R-CAN communication line 700.

The R-CAN communication line 700 is a redundant CAN communication line that is used when a chassis CAN (C-CAN) fails.

The second processor and the third processor of the second control unit 200 are connected to each other through an input and output terminal of the GPIO to transmit and receive signals. Therefore, the first controller 210 and the second controller 220 as a dual structure in the RWA 20 may transmit and receive signals to and from each other.

Here, the first control unit 100, the first controller 210, and the steering angle sensor 500 are configured to transmit and receive signals to and from one another through a CAN communication line 600.

When the first CAN communication unit 110 fails or the SFA 10 itself is not normal, the first processor transmits the failure information of the SFA 10 to the second control unit 200 through the P-CAN communication line. Here, the failure of the SFA 10 may include at least one of the failure of the first control unit 100, the failure of driving of the first motor 11, or the failure of the first CAN communication unit 110.

As such, when the functional failure of the SFA 10 is determined, the data received from the steering angle sensor 500 is applied to the second controller 220 in the RWA 20 through an R-CAN communication unit 221 connected to the R-CAN communication line 700, and the driving force of the motor controlled by the second processor of the second controller 220 is applied to the wheel so that a user-requested steering angle may be applied to the wheel.

Therefore, when the SFA 10 is determined to be malfunctioning, the RWA 20 including the second controller 220 inputs the steering angle to the wheel of the vehicle based on the steering angle input measured by the steering angle sensor 500.

Furthermore, the first control unit 100, the first controller 210 of the second control unit 200, and the steering angle sensor 500 are configured to be powered through a first battery line 300, and the second controller 220 of the second control unit 200 is configured to be powered through a second battery line 400.

In other words, because the failure of the SFA 10 may include the failure of the power applied from the first battery line 300, the second controller 220 is configured to apply steering power to the wheel by being electrically connected to the second battery line 400.

Moreover, when the failure of the first battery line 300 is determined, the steering angle sensor 500 that is always connected to the first battery line 300 may be supplied with power through a built-in battery pack 510 built into the steering angle sensor 500. Therefore, in the event of a failure of a sub-component of the SFA 10 or a failure of the power supply of the first battery line 300, steering input of the wheel is performed through the second controller 220 electrically connected to the second battery line 400 based on the measurement of the steering angle sensor 500 that is powered through the built-in battery pack 510.

The first processor may read a code corresponding to the failure information based on the previously stored library data, convert the failure information into data, generate a signal including the data, and transmit the failure information to the second processor.

The first processor may generate a signal by including a start code and an end code in the data and binarizing the code set in the library data.

When receiving the failure signal from the first processor through the P-CAN communication, the second processor detects the start code and the end code, converts the binary code between the start code and the end code into a decimal number, searches for a matching code from the library data, and reads the failure information.

As such, the first processor in the SFA 10 may determine the failure of the SFA 10 and transmit the failure information to the first controller 210 of the second control unit 200, allowing the second control unit 200 in the RWA 20 to determine the failure of the SFA 10.

In another embodiment, the first processor and the second processor may independently determine the failure of the SFA 10, and furthermore, the second control unit may mutually transmit the failure of the RWA 20. In other words, the first processor and the second processor are interchangeably connected to each other through C-CAN, R-CAN, and P-CAN, each performing transmission and reception of failure messages to each other.

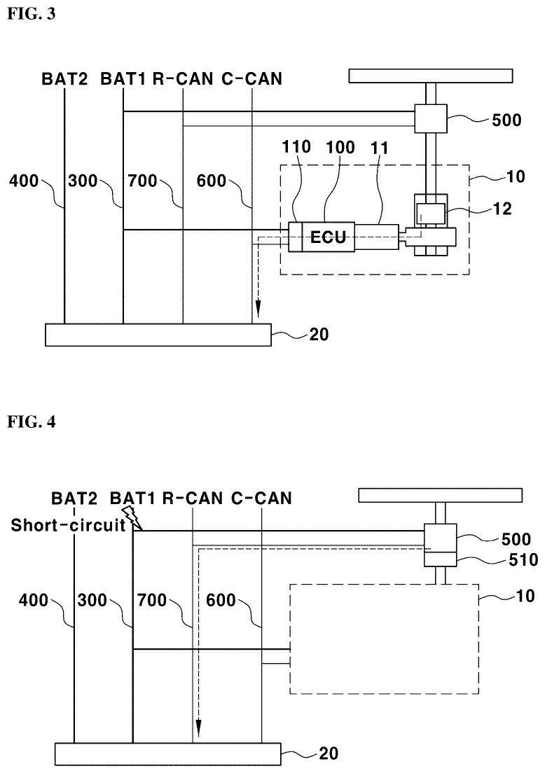

FIG. 3 illustrates how the steer-by-wire system operates under normal operating conditions of the SFA 10 in an embodiment of the present disclosure.

The SFA 10 may include: the first control unit 100 including a single controller, and the first battery line 300 configured to supply power to the first control unit 100. Moreover, the SFA 10 may transmit and receive information to and from the steering angle sensor 500 and the first controller 210 of the second control unit 200 through the first CAN communication unit 110, which is a sub-component of the first control unit 100.

As an embodiment of the present disclosure, when a user's steering angle input is applied, the input of the steering wheel is applied, and the steering angle input is received through the steering angle sensor 500 disposed on a steering column. The received steering angle input is transmitted to the first CAN communication unit 110 and to the second CAN communication unit 211 in the RWA 20 through the CAN communication line 600.

When the steering angle input is applied, the SFA 10 supplies power to the first motor 11 to apply a reaction force to the steering wheel, and the RWA 20 transmits a driving force to the wheel so that the wheel adopts the steering angle input measured by the steering angle sensor 500.

Moreover, the first control unit 100 in the SFA 10 and the first controller 210 in the RWA 20 may transmit and receive information to and from each other through the P-CAN communication. The first control unit 100 and the first controller 210 are configured to receive power by being electrically connected to the first battery line 300.

As such, when the SFA 10 or the first battery line 300 performs normally, the steering angle is input to the wheel through the first control unit 100 and the first controller 210.

As an embodiment of the present disclosure, FIG. 4 illustrates a fail-safe operation performed such that, in the event of a failure of the SFA 10, the steering angle is input to the wheel by the second controller 220 that communicates with the steering angle sensor 500.

In an embodiment of the present disclosure, the failure of the SFA 10 may include the failures of the first control unit 100, first CAN communication unit 110, CAN communication line 600, and first motor 11, which constitute the SFA 10. The failure of the SFA 10 includes any situation where power is not applied to the SFA 10, such as a short circuit of the first battery line 300. In other words, the failure of the SFA 10 includes any situation in which normal operation of the SFA 10 is impossible.

The first controller 210 of the second control unit 200 may receive the information indicating whether the SFA 10 fails from the first control unit 100 through a P-CAN communication line 800 positioned between the first control unit 100 and the first controller 210. Furthermore, the failure of the SFA 10 is determined through the first control unit 100 or a higher-level controller in the vehicle. In addition, when a power signal input to the SFA 10 is abnormal, a failure is determined through the first control unit 100, and when driving of the SFA 10 beyond a normal range is detected, the higher-level controller of the vehicle determines a failure through a sensor and simultaneously transmits a failure signal to the first control unit 100.

Moreover, the failure signal of the SFA 10 may be transmitted to the second control unit 200.

When the SFA 10 is determined to have failed, the steering input information of the steering wheel received from the steering angle sensor 500 is transmitted to the second control unit 200 through the R-CAN communication line 700. More specifically, the steering angle input measured by the steering angle sensor 500 is received by the second controller 220.

Thereafter, the second controller 220 applies a driving force to the motor connected to the wheel of the vehicle. Here, the motor connected to the second controller 220 in the RWA 20 receives power from the second battery line 400 and inputs the steering angle to the wheel.

Moreover, when the SFA 10 is determined to have failed, the steering angle sensor 500, disposed on the steering column, may transmit the steering angle input measured by the steering angle sensor 500 using the built-in battery pack 510. Therefore, the steering angle sensor 500 may independently operate with power supplied independently from the first battery line 300, and the measured steering angle input is transmitted to the second controller 220 of the second control unit 200 through the R-CAN communication line 700.

As is apparent from the above description, the present disclosure may have the following effects by the above-described elements, and combination and using relations thereof.

According to the present disclosure, when the SFA fails, the steering angle sensor and the control unit in the RWA may communicate with each other to perform emergency steering based on the input steering angle, thereby providing a fail-safe effect.

Moreover, the present disclosure provides an environment for securing redundancy in the event of a failure of the SFA, without requiring a dual power pack (a controller and a motor), thereby providing a highly reliable steer-by-wire system.

The detailed description is merely illustrative of the present disclosure. In addition, while the above description shows and describes certain embodiments of the present disclosure, it is understood that the present disclosure may be applied in various other combinations, modifications, and environments. In other words, changes or modifications may be made within the scope of the idea disclosed herein, the scope of equivalents to the described disclosure, and/or the scope of ordinary skill or knowledge in the art. The embodiments describe the best mode for implementing the technical idea of the present disclosure, and various changes required for specific application fields and uses of the present disclosure are possible. Therefore, the detailed description of the present disclosure is not intended to limit the present disclosure to the disclosed embodiments. Furthermore, the appended claims should be construed to cover other embodiments.

What is claimed is:

1. A steer-by-wire system comprising:
a first control unit comprising a first controller area network (CAN) communication unit disposed in a steering force actuator (SFA) and connected to a CAN communication line;
a second control unit comprising a second CAN communication unit disposed in a road wheel actuator (RWA) and connected to the CAN communication line;
a steering angle sensor configured to measure an input of a steering wheel and connected to the first control unit through the CAN communication line; and
a redundant-CAN (R-CAN) communication line to which the steering angle sensor and the second control unit are connected,
wherein, when a failure of the SFA is determined, the second control unit is configured to communicate with the steering angle sensor using the R-CAN communication line and perform steering input to a wheel.

2. The steer-by-wire system of claim 1, wherein the second control unit comprises:
a first controller comprising the second CAN communication unit; and
a second controller comprising an R-CAN communication unit connected to the R-CAN communication line.

3. The steer-by-wire system of claim 2, further comprising a first battery line connected to the first control unit, the first controller, and the steering angle sensor.

4. The steer-by-wire system of claim 3, further comprising a second battery line connected to the second controller.

5. The steer-by-wire system of claim 4, wherein the failure of the SFA comprises at least one of a short circuit of the first battery line, a failure of the first control unit, a failure of the first CAN communication unit, or a failure of the CAN communication line.

6. The steer-by-wire system of claim 3, wherein the SFA comprises:
a first motor configured to output a reaction force to the steering wheel; and
a first sensor configured to measure a driving amount of the first motor,
wherein the first control unit is configured to control the driving amount of the first motor.

7. The steer-by-wire system of claim 2, wherein the first control unit is connected to the first controller through a private-CAN (P-CAN) communication.

8. The steer-by-wire system of claim 2, wherein the first controller and the second controller are connected to each other through an input and output terminal of a general purpose input output (GPIO).

9. The steer-by-wire system of claim 1, wherein the steering angle sensor comprises a built-in battery pack, and wherein when the failure of the SFA is determined, the steering angle sensor is configured to measure a steering angle of the steering wheel with power supplied from the built-in battery pack.

10. A steer-by-wire system comprising:
a steering force actuator (SFA) including a first control unit and a first CAN communication unit connected to a CAN communication line;
a road wheel actuator (RWA) including a second control unit and a second CAN communication unit connected to the CAN communication line;
a steering angle sensor configured to sense steering input from a steering wheel and connected to the first control unit through the CAN communication line;
a redundant CAN (R-CAN) communication line connecting the steering angle sensor to the second CAN communication unit; and
wherein the second control unit is configured to:
receive steering input information from the steering angle sensor through the R-CAN communication line in response to detection of a failure of the SFA, and
steer a wheel based on the received steering input information.

11. The steer-by-wire system of claim 10, wherein the second control unit comprises:
a first controller associated with the second CAN communication unit; and
a second controller associated with an R-CAN communication unit connected to the R-CAN communication line.

12. The steer-by-wire system of claim 11, further comprising a first battery line connected to the first control unit, the first controller, and the steering angle sensor.

13. The steer-by-wire system of claim 12, further comprising a second battery line connected to the second controller.

14. The steer-by-wire system of claim 13, wherein the SFA comprises:
a first motor configured to output a reaction force to the steering wheel; and
a first sensor configured to measure a driving amount of the first motor,
wherein the first control unit is configured to control the driving amount of the first motor.

15. The steer-by-wire system of claim 11, wherein the first control unit is connected to the first controller through a private-CAN (P-CAN) communication.

16. The steer-by-wire system of claim 11, wherein the first controller and the second controller are connected to each other through an input and output terminal of a general purpose input output (GPIO).

17. The steer-by-wire system of claim 10, wherein the steering angle sensor comprises a built-in battery pack, and wherein when the failure of the SFA is determined, the steering angle sensor is configured to measure a steering angle of the steering wheel with power supplied from the built-in battery pack.
